(19) United States
(12) Patent Application Publication
(10) Pub. No.: US 2014/0345881 A1
(43) Pub. Date: Nov. 27, 2014

(54) PRESSURE CONTROL SYSTEM FOR FIRE EXTINGUISHING EQUIPMENT

(71) Applicant: Young Hyoun Ko, (US)

(72) Inventor: Young Hyoun Ko, Suwon-si (KR)

(21) Appl. No.: 14/375,978

(22) PCT Filed: Jan. 25, 2013
(86) PCT No.: PCT/KR2013/000602

§ 371 Date: Jul. 31, 2014

(30) Foreign Application Priority Data
Feb. 1, 2012 (KR) 10-2012-0010336

(51) Int. Cl. A62C 37/00; A62C 35/64; A62C 35/60

(52) U.S. Cl. CPC A62C 37/00; A62C 35/60; A62C 35/64
USPC 169/16

(57) ABSTRACT

Provided is a pressure control system for fire extinguishing equipment, the system including: valves installed at pipes for receiving water supplied from a fire-extinguishing water tank; a digital indicator configured to measure water pressure of the valves or water pressure of the pipes in which the valves are installed and to transmit a signal for abnormality when a value of the measured water pressure does not correspond to a predetermined range; a main control unit configured to transmit a signal for pressure reduction intended for reducing the water pressure of the valves when the signal for abnormality is received from the digital indicator; and a motor operating valve (MOV) installed at the pipes or the valves and configured to reduce the water pressure when the signal for pressure reduction is received.

### CROSS-REFERENCE TO RELATED APPLICATION

This application is the U.S. national stage application of International Patent Application No. PCT/KR2013/000602, filed Jan. 25, 2013, which claims priority to Korean Application No. 10-2012-0010336, filed Feb. 1, 2012, the disclosures of each of which are incorporated herein by reference in their entirety.

### TECHNICAL FIELD

The present invention relates to a pressure control system for fire extinguishing equipment and, more particularly, to a pressure control system for fire extinguishing equipment which enables automatic pressure control of the fire extinguishing equipment.

### BACKGROUND ART

An existing fire extinguishment and water supply method refers to a method performed in such a manner as to install a fire-extinguishing water tank in a basement or the lowest layer portion of a building and to apply pressure thereto. However, the water supply pressure method of a high-rise building is influenced by a fire extinguishing pressure (about 10 kg/cm²) in a pipe when the pipe is a fire extinguishing pipe of 100 m in length vertically and a pressure in a range of 0.98 kg/cm² based on the law of gravity is applied with regard to construction based on a design in which a fire-extinguishing water tank is installed at a high-rise portion and a natural head pressure method is generalized. At this time, when the pressure is beyond a radiation pressure (7 kg/cm²) of a fire hose station which is effective pressure in light of the fire defense regulation, and the pipe is beyond 120 m in pressure in light of the fire defense regulation, and the pipe is beyond 120 m in length, pressure anomaly according to the fire defense regulation (at least 12 kg/cm² in pressure of a type approval testing product for fire extinguishing equipment according to the Korean Firefighting Testing Corporation) affects pipes, valves, heads and other components.

When the pressure is beyond at least 12 kg/cm² in pressure of the type approval testing product, a pressure reducing valve is installed at an angle valve of the fire hose station and is also used in a horizontal main pipe. However, when the pressure reducing valve is out of order, the pressure in the pipe reaches a threshold value, and thus the pressure is leaked from respective constitutive facility components (piping screw parts, a sprinkler head, inserts, valve joints), thereby causing much secondary material damage.

Also, since the pressure reducing valve is usually located at a PIT facility or a valve chamber which is not be easily observed by persons, the conventional system is configured of a system which cannot easily confirm whether or not the pressure reducing valve is out of order. Thus, when abnormality is generated from any constitutive element, a manager should individually check the constitutive elements of the facility with the naked eye, thereby causing temporal damage resulting visual inspection and a late dealing for repairing.

In a case where a fire along with property damage occurs from any place, it is difficult to obtain a source of water supply emergently necessary for first-aid fire fighting for the prevention of primary property damage which has been originally targeted, rather than for secondary property damage, thereby causing blocking of fire extinguishment for preventing disasters as rapid reaction to the occurrence of the fire.

Thus, according to the conventional art, due to overpressure generated from a second side of an alarm valve of a wet sprinkler system, the manager should regularly confirm once a month a pressure gage of a sprinkler test box or should directly check a pressure retaining state (at least 12 kg/cm² in pressure) in a pipe with the naked eye, thereby draining fire-fighting water in the pipe.

### THE DETAILED DESCRIPTION OF THE INVENTION

### Technical Problem

Accordingly, the present invention has been made keeping in mind the above problems occurring in the prior art, and an object of the present invention is to provide a pressure control system for fire extinguishing equipment that displays the pressure state of a pipe for fire-fighting and extinguishing equipment so that water leak can be prevented from being generated from the pipe, an angle valve of a fire hose station, a sprinkler (a valve, a head, an end) and the like due to overpressure in piping.

Also, another object of the present invention provides is to provide a pressure control system for fire extinguishing equipment that allows flexible and rapid management of the fire extinguishment equipment while meeting an original purpose of first-aid firefighting pursuant to the fire defense regulation by regularly monitoring pressure in a fire extinguishing pipe, performing rapidly control according to an increase of the pressure in the pipe, and regularly and automatically adjusting the pressure in the pipe in order to prevent secondary property damage resulting from the increase of the pressure in the fire extinguishing pipe for fire-fighting equipment.

### Solution to Problem

In order to solve the above problems, according to an embodiment of the present invention, there is provided a pressure control system for fire extinguishing equipment, the system including: valves installed at pipes for receiving water supplied from a fire-extinguishing water tank; a digital indicator configured to measure water pressure of the valves or the pipes in which the valves are installed and to transmit a signal for abnormality when a value of the measured water pressure does not correspond to a predetermined range; a main control unit configured to transmit a signal for pressure reduction intended for reducing the water pressure of the valves when the signal for abnormality is received from the digital indicator; and a motor operating valve (MOV) installed at the pipes or the valves and configured to reduce the water pressure when the signal for pressure reduction is received.

According to another embodiment of the present invention, the digital indicator may measure water pressure of a pipe on a first side corresponding to the pipe arranged at the fire-extinguishing water tank and water pressure of a pipe on a second side corresponding to the pipe arranged at an opposite side of the first side.

According to still another embodiment of the present invention, the pressure control system for fire extinguishing equipment may further include an integrated monitoring control unit for fire-fighting equipment configured to display an abnormal condition generated from the pipes via the main control unit when abnormality is generated from the pipes.

According to still another embodiment of the present invention, the main control unit may receive information on the existence of abnormality in the amount of fire extinguishing water in the fire-extinguishing water tank, information on the existence of abnormality in a fire extinguishing equipment pump, information on the operation of a smoke removing fan of a vestibule, information on the operation of storm and flood pumps for fire-fighting equipment or information on the opening and closing conditions of smoke ventilators for each floor from each measurement sensing unit.

According to still another embodiment of the present invention, the integrated monitoring control unit for fire-fighting equipment may display the information on the existence of abnormality in the fire-extinguishing water tank on the amount of fire extinguishing water, the information on the existence of abnormality in a fire extinguishing equipment pump, the information on the operation of a smoke removing fan of a vestibule, the information on the operation of storm and flood pumps for fire-fighting equipment or the information on the opening and closing conditions of smoke ventilators for each floor according to control of the main control unit.

According to still another embodiment of the present invention, the pressure control system for fire extinguishing equipment may further include a mobile terminal connected to the integrated monitoring control unit via a WI-FI zone or a 3G or 4G network and configured to receive text messages for a warning situation, to monitor fire-fighting equipment and to execute remote control or an warning check.

According to still another embodiment of the present invention, the pressure control system for fire extinguishing equipment may further include a telegraphic repeater configured to receive the signal for abnormality from the digital indicator and to transmit the received signal for abnormality to the main control unit.

According to still another embodiment of the present invention, the telegraphic repeater may perform communication via an RS232 or RS485 method or an internet method.

According to still another embodiment of the present invention, the valves may be configured of a pressure reducing valve or an alarm valve.

### Advantageous Effects of Invention

According to the present invention, the pressure conditions of a pipe of fire-fighting extinguishment equipment can be displayed, and due to overpressure in pipes, water leak can be prevented from being generated from the pipes, angle valves of a fire hose station, spring coolers (valves, heads, and ends).

Also, according to the present invention, in order to prevent secondary property damage resulting from an increase of pressure in a fire extinguishing pipe for fire-fighting equipment, by regularly monitoring the pressure in the fire extinguishing pipe and automatically adjusting regular pressure of the pipe through rapid control according to the increase of the pressure in the pipe, an original purpose of first-aid firefighting can be satisfied by the fire extinguishing method, and the fire extinguishing equipment can be flexibly and rapidly managed.

Also, according to the present invention, the pressure control system (auto control and observation) can be installed at fire extinguishing facilities for factories and industrial complexes of high-rise and large buildings and other buildings which may cause a problem of water leak due to overpressure in a pipe for fire extinguishing equipment and can consistent with a purpose based on the Korean fire defense regulation (the protection of lives and property). Furthermore, the pressure control system can reduce secondary property damage and can be applied in foreign countries as well as in the Republic of Korea so that a national industrial network's status can be obtained, and a planned and integrated observation system for fire extinguishing equipment can be established, and a pressure condition can be confirmed via a manger's smart phone anytime or anywhere, thereby leading to an effect of rapid and accurate business processing.

### BRIEF DESCRIPTION OF DRAWINGS

FIG. 1 is a view for explaining a pressure control system for fire extinguishing equipment according to an embodiment of the present invention;

FIG. 2 is a view illustrating a pressure reducing valve according to the embodiment of the present invention;

FIG. 3 is a view illustrating an alarm valve according to the embodiment of the present invention;

FIG. 4 is a view illustrating a fire-extinguishing water tank according to the embodiment of the present invention;

FIG. 5 is a view illustrating a digital indicator according to the embodiment of the present invention; and

FIG. 6 is a conceptual view for explaining a pressure control method of the pressure control system for the fire extinguishing equipment.

### MODE FOR THE INVENTION

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

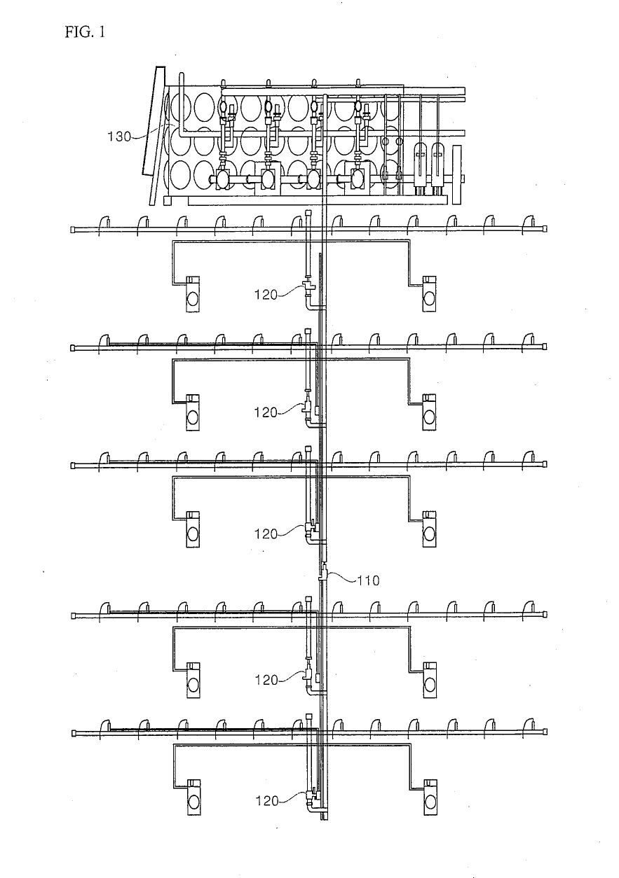

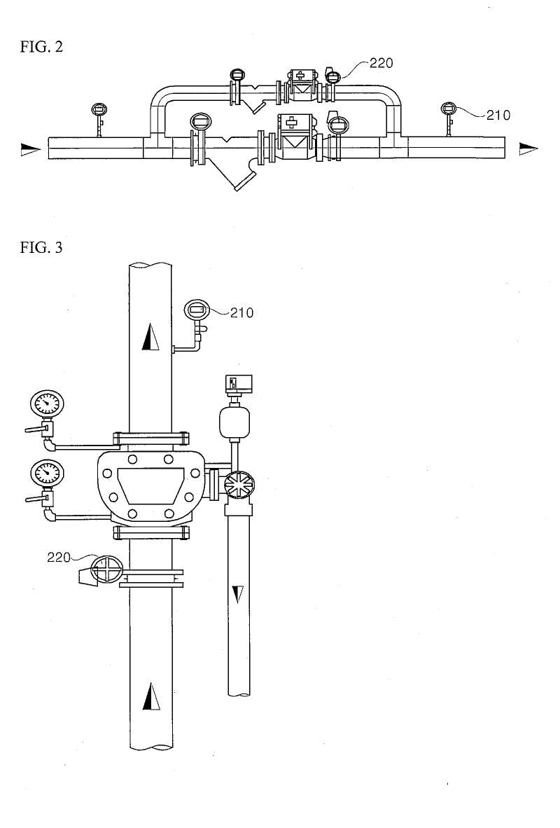

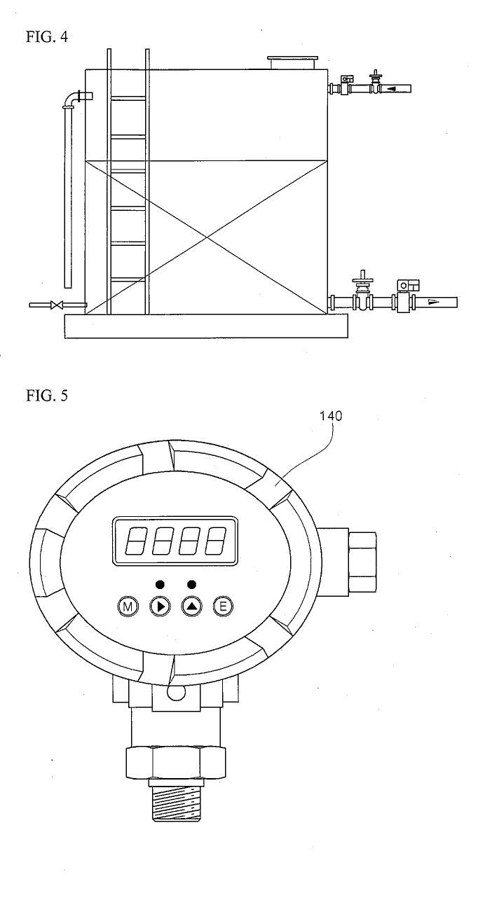

FIG. 1 is a view for explaining a pressure control system for fire extinguishing equipment according to an embodiment of the present invention. Also, FIG. 2 is a view illustrating a pressure reducing valve according to the embodiment of the present invention and FIG. 3 is a view illustrating an alarm valve according to the embodiment of the present invention. Also, FIG. 4 is a view illustrating a fire-extinguishing water tank 130 according to the embodiment of the present invention and FIG. 5 is a view illustrating a digital indicator 140 according to the embodiment of the present invention.

A pressure control system for fire extinguishing equipment according to an embodiment of the present invention will be described with reference to FIG. 1.

Valves 110, 120 are installed at pipes for receiving water supplied from the fire-extinguishing water tank 130. At this time, the valves are composed of a pressure reducing valve 110 or an alarm valve 120. The pressure reducing valve 110 is illustrated in FIG. 2, the alarm valve 120 is illustrated in FIG. 3, and the fire-extinguishing water tank 130 is illustrated in FIG. 4.

The digital indicator 140 is configured as illustrated in FIG. 5 along with the pressure reducing valve 110 or the alarm valve 120 illustrated in FIGS. 2 and 3.

On the basis of the pressure reducing valve 110, a vertical pipe is divided into a first side near to the fire-extinguishing water tank 130 and a second side which is an opposite side facing the first side, and the digital indicator 140 for measuring water pressure is installed at the pressure reducing valve 110 or the pipes.

The digital indicator 140 measures water pressure of the pipes arranged at the first side and the second side on the basis of the valves, and transmits a signal for abnormality when a value of the measured water pressure does not correspond to a predetermined range. More specifically, a water pressure value in a normal state or a range of the water pressure value is set with regard to the digital indicator 140, and the digital indicator 140 regularly monitors whether or not a water pressure value is normal or abnormal and transmits a signal for abnormality while displaying the occurrence of an abnormal matter when the measured water pressure value is beyond a predetermined water pressure value or a range of the water pressure value, or other detectable abnormal matters except for the abnormal matter are generated.

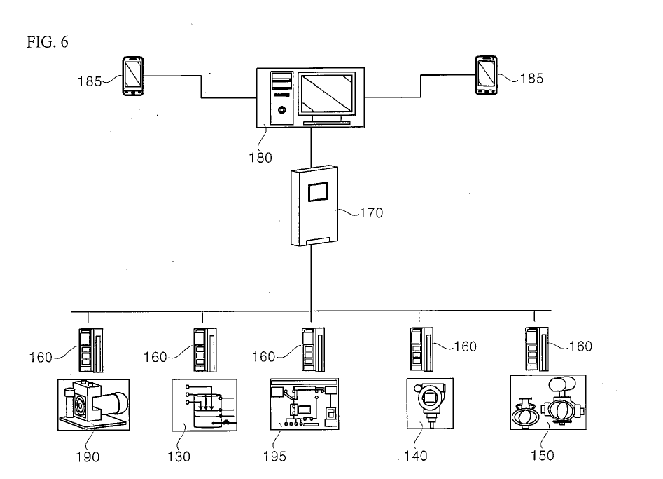

FIG. 6 is a conceptual view for explaining a pressure control method of the pressure control system for the fire extinguishing equipment.

A telegraphic repeater 160 may receive a signal for abnormality transmitted from a measurement sensing unit installed in each facility and may transmit the signal for abnormality to a main control unit 170 by communicating the signal for abnormality in an RS232 or RS485 method, or an internet method.

As the main control unit 170 receives the signal for abnormality from the telegraphic repeater 160, the main control unit transmits the signal for pressure reduction intended to reduce water pressure of the valves 110, 120, and the telegraphic repeater 160 transmits the signal for pressure reduction to a motor operating valve (MOV) 150.

Also, the main control unit 170 may receive information on the existence of abnormality in the amount of fire extinguishing water in the fire-extinguishing water tank 130, information on the existence of abnormality in a fire extinguishing equipment pump 190, information on the operation of a smoke removing fan of a vestibule, information on the existence of abnormality in an insulation system 195, information on the operation of storm and flood pumps for fire-fighting equipment or information on the opening and closing conditions of smoke ventilators for each floor via the telegraphic repeater 160 from respective measurement sensing units.

The motor operating valve 150 is installed at the pipes or the valves 110, 120, namely, the pressure reducing valve 110 or the alarm valve 120 and is opened to reduce water pressure by receiving the signal for pressure reduction.

Meanwhile, an integrated monitoring control unit 180 for fire-fighting equipment receives information on the occurrence of abnormality of the pipes transmitted from the main control unit 170, and displays the received the information on the occurrence of abnormality of the pipes by the main control unit.

Also, the integrated monitoring control unit 180 for fire-fighting equipment displays the information on the existence of abnormality in the amount of fire extinguishing water in the fire-extinguishing water tank 130, the information on the existence of abnormality in the fire extinguishing equipment pump 190, the information on the operation of a smoke removing fan of a vestibule, the information on the existence of abnormality in the insulation system 195, the information on the operation of storm and flood pumps for fire-fighting equipment or the information on the opening and closing conditions of smoke ventilators for each floor according to control of the main control unit.

The user may access to the integrated monitoring control unit via a WI-FI zone or a 3G or 4G network using the mobile communication terminal 185, thereby receiving text messages for a warning situation, monitoring fire-fighting equipment, and executing remote control or a waning situation check.

As previously described, in the detailed description of the invention, having described the detailed exemplary embodiments of the invention, it should be apparent that modifications and changes can be made by persons skilled without deviating from the spirit or scope of the invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims and their equivalents.

What is claimed is:

1. A pressure control system for fire extinguishing equipment, which measures water pressure of pipes of the extinguishing equipment to open and close valves according to the measured water pressure, the system comprising:
valves installed at pipes for receiving water supplied from a fire-extinguishing water tank;
a digital indicator configured to measure water pressure of the valves or water pressure of the pipes in which the valves are installed and to transmit a signal for abnormality when a value of the measured water pressure does not correspond to a predetermined range;
a main control unit configured to transmit a signal for pressure reduction intended for reducing the water pressure of the valves when the signal for abnormality is received from the digital indicator; and
a motor operating valve (MOV) installed at the pipes or the valves and configured to reduce the water pressure when the signal for pressure reduction is received.

2. The system of claim 1, wherein the digital indicator measures water pressure of a pipe on a first side corresponding to the pipe arranged at the fire-extinguishing water tank and water pressure of a pipe on a second side corresponding to the pipe arranged at an opposite side of the first side.

3. The system of claim 1, further comprising: an integrated monitoring control unit for fire-fighting equipment configured to display an abnormal condition generated from the pipes by the main control unit when abnormality is generated from the pipes.

4. The system of claim 1, wherein the main control unit receives, from each measurement sensing unit, information on the existence of abnormality in the fire-extinguishing water tank on the amount of fire extinguishing water, information on the existence of abnormality in a fire extinguishing equipment pump, information on the operation of a smoke removing fan of a vestibule, information on the operation of storm and flood pumps for fire-fighting equipment or information on the opening and closing conditions of smoke ventilators for each floor.

5. The system of claim 4, wherein the integrated monitoring control unit for the fire-fighting equipment displays the information on the existence of abnormality in the fire-extinguishing water tank on the amount of fire extinguishing water, the information on the existence of abnormality in a fire extinguishing equipment pump, the information on the operation of a smoke removing fan of a vestibule, the information on the operation of storm and flood pumps for fire-fighting equipment or the information on the opening and closing conditions of smoke ventilators for each floor according to control of the main control unit.

6. The system of claim 3, further comprising a mobile terminal connected to the integrated monitoring control unit via a WI-FI zone or a 3G or 4G network and configured to receive text messages for an alarm situation, to monitor fire-fighting equipment and to execute remote control or an alarm check.

7. The system of claim 1, further comprising a telegraphic repeater configured to receive the signal for abnormality from the digital indicator and to transmit the received abnormal signal to the main control unit.

8. The system of claim 7, wherein the telegraphic repeater performs communication via an RS232 or RS485 method or an internet method.

9. The system of claim 1, wherein the valves may be configured of a pressure reducing valve or an alarm valve.
